(19) United States
(12) Patent Application Publication
(10) Pub. No.: US 2008/0089278 A1
(43) Pub. Date: Apr. 17, 2008

(54) Method and frame structure for supporting dynamic channel allocation and dynamic power allocation in frequency reuse partitioning based OFDMA system

(75) Inventors: Kyung Hi Chang, Seoul (KR); In Suk Cha, Incheon (KR); Joo Heo, Incheon (KR)

Correspondence Address: MORGAN LEWIS & BOCKIUS LLP, 1111 PENNSYLVANIA AVENUE NW, WASHINGTON, DC, 20004, US

(73) Assignee: Inha-Industry Partnership Institute

(21) Appl. No.: 11/545,723

(22) Filed: Oct. 11, 2006

(51) Int. Cl. H04Q 7/00

(52) U.S. Cl. 370/329

(57) ABSTRACT

Provided are a dynamic channel/power allocation method for an FRP-based OFDMA system and a frame/slot structure capable of supporting the dynamic channel/power allocation method. In the FRP-based OFDMA system, each of cells has an inner cell, an outer cell and a plurality of sectors and performs data communication with a plurality of MSs therein through one or more orthogonal subchannel groups. In the dynamic channel/power allocation method, a BS receives a feedback channel condition from an MS provided with a service of the BS and allocates a subchannel group with a high SINR to each MS in consideration of the fairness and the distance information of each MS. Power is allocated to each MS on the basis of the conditions of a channel allocated to each MS, thereby obtaining a multi-user diversity gain.

### BACKGROUND OF THE INVENTION

1. Field of the Invention

The present invention relates to an Orthogonal Frequency Division Multiple Access (OFDMA) system. In particular, the present invention relates to a dynamic channel/power allocation method for a Frequency Reuse Partitioning (FRP)-based OFDMA system and a frame/slot structure capable of supporting the dynamic channel/power allocation method.

2. Description of the Related Art

Demands for a new service that can provide mobility and a high data rate in radio environments is increasing. In Korea, efforts for technical development and standardization are being made to provide a 2.3-GHz portable Internet service and a Mobile Broadband Wireless Access (MBWA) service.

An Orthogonal Frequency Division Multiplexing (OFDM) technique is one of the most remarkable techniques because it can provide high TX efficiency and a simple channel equalization scheme.

Operations of a transmitter (a base station (BS)) and a receiver (a mobile station (MS)) in an OFDM wireless communication system will be briefly described below.

In an OFDM transmitter, input data is processed by a scrambler, an encoder and an interleaver and the result data is modulated with a subcarrier. At this point, the transmitter provides a variety of variable data rates. A coding rate, an interleaving size and a modulation scheme vary depending on the variable data rates.

In general, a coding rate of the encoder is 1/2, 3/4, etc. The interleaver size for preventing a burst error is determined according to the number of encoded bits per OFDM symbol. Depending on desired data rates, the modulation scheme may be a Quadrature Phase Shift Keying (QPSK) modulation scheme, an 8 ary PSK (8 PSK) modulation scheme, a 16 ary Quadrature Amplitude Modulation (16 QAM) modulation scheme, or a 64 QAM.

A predetermined number of sub-carriers pass through an IFFT block to form one OFDM signal. In order to remove intersymbol interference in a multipath channel environment, a guard time is inserted into the OFDM signal. Then, the OFDM signal with the guard time passes through a symbol waveform generator and is transmitted over a radio channel by a radio frequency processor.

The receiver performs an operation reverse to that of the transmitter and further performs a synchronization operation. First, an operation of estimating frequency offset and symbol offset is carried out by using predetermined symbols. Then, data symbol in which the inserted guard time is removed passes through an FFT block to recover a predetermined number of sub-carriers containing a predetermined number of pilots.

To overcome path delay phenomenon, an equalizer estimates a channel state to remove signal distortion caused by channel. Data in which a channel response is compensated by the equalizer is converted into bit sequence and then passes through a deinterleaver. Then, the bit sequence passes through a decoder and a descrambler for error correction and is finally recovered into the final data.

In such an OFDM scheme, input data are transmitted in parallel over multiple carriers at a low speed, instead of high transmission using a single carrier. That is, the OFDM scheme can provide an efficient digital implementation of the modulator/demodulator and is less influenced by frequency selective fading or narrowband interference.

Meanwhile, in a cellular environment considering the mobility, a frequency reuse efficiency is an important factor in determining the performance of the OFDM-based system.

When the frequency reuse factor is 1, it is ideal in terms of throughput of the BS because the BS can use all radio resources. In this case, however, the frequency reuse factor of 1 causes serious performance degradation due to intercell interference.

In order to implement the frequency reuse factor of 1 by solving the performance degradation due to the intercell interference, a Flash-OFDM system developed by Flarion uses a frequency hopping scheme to change sub-carriers into predetermined patterns, and uses Low Density Parity Check (LDPC) channel coding to prevent the performance degradation caused by the intercell interference.

Another scheme for implementing the frequency reuse factor of 1 is to randomly puncture subcarrier so as to reduce collision between a neighboring cell and a sub-carrier.

In the case of a system maintaining the frequency reuse factor of 1, as a load of traffic increases, the performance degradation is expected in cell boundary having poor channel condition due to the intercell interference.

Therefore, interest in a frequency reuse partitioning scheme is rapidly growing. The frequency reuse partitioning scheme is a method for securing the performance of an MS located in an area having a poor channel condition, such as a cell boundary, and improving the spectral efficiency.

That is, the frequency reuse partitioning is one of the effective methods that can improve the spectral efficiency of a cellular system.

FIG. 1 is a schematic diagram illustrating the concept of a conventional FRP scheme.

In the FRP scheme, a cell is divided into an inner cell and an outer cell depending on the distance from a BS to an MS or on the strength of a pilot signal transmitted from a BS to an MS. Different Frequency Reuse Factors (FRFs) are used for the inner cell and the outer cell.

Referring to FIG. 1, when an MS is located in an outer cell, a subchannel with an FRF of 7 is allocated to the MS. On the other hand, when an MS is located in an inner cell, a subchannel with an FRF of 1 is allocated to the MS.

The reason for allocation of subchannels with different FRFs is that an MS near to a BS has a better channel quality than an MS remote from the BS because the near MS is smaller than the remote MS in terms of a power loss due to a path loss, but an MS in a cell boundary region is seriously affected by intercell interference and the power loss due to the path loss, which degrades the performance of a cellular system and restricts a data rate and a cell coverage.

Because an MS in an inner cell has a good channel quality, a channel with a low FRF providing a proper Quality of Service (QoS) is allocated to the MS to increase a cell capacity. In addition, because an MS in an outer cell has a relatively poor channel quality, a channel with a high FRF is allocated to the MS to increase a cell coverage. An MS in a cell boundary region may be provided with a QoS and a data rate that are about the same as those of the MS in the inner cell.

Recently, researches are being conducted on a radio resource allocation method for effectively using limited frequency resources while reducing intercell interference.

If a channel is stationary and if a transmitter accurately knows a channel response of an MS, a combination of a water-filling scheme and an adaptive modulation scheme is known to be optimal.

However, the water-filling scheme is mainly researched for only a single-user system or a multi-user system that supports stationary resource allocation. For example, a Time Division Multiple Access (TDMA) system or a Frequency Division Multiple Access (FDMA) system allocates a given time slot or a given frequency channel to each MS and then applies the adaptive modulation scheme to the channels of MSs.

However, a multi-user OFDM scheme using the adaptive modulation scheme based on the stationary resource allocation cannot provide the optimal resource allocation that can be provided by an actual system.

The reason for this is that many channels are unavailable in the water-filling scheme because of the existence of subchannels, which undergo deep fading due to the characteristics of frequency selective channels, or subchannels to which a large amount of power is difficult to allocate.

However, a channel that acts as a deep fading channel for an MS may not be a deep fading channel for another MS. In general, as the number of MSs increases, the probability that each subchannel of an OFDM system will be a deep fading channel for all the MSs decreases.

That is, as the number of MSs increases, they undergo an independent channel, thereby making it possible to obtain a multi-user diversity gain.

What is therefore required is a method that can provide the optimal resource allocation by dynamically allocating better channels to MSs according to channel information of all the MSs, applying an adaptive modulation scheme using the allocated channels, and dynamically allocating power according to the conditions of the allocated channels.

### SUMMARY OF THE INVENTION

An advantage of the present invention is that it provides a dynamic channel allocation method for an FRP-based OFDMA system, which dynamically allocates a subcarrier of a subchannel group with a high SINR to each MS on the basis of the channel conditions of each MS, thereby making it possible to allocate a better channel to each MS.

The present invention also provides a dynamic power allocation method for an FRP-based OFDMA system, which dynamically allocates power to each MS on the basis of the conditions of the allocated channel of each MS, thereby making it possible to obtain the multi-user diversity gain.

The present invention also provides a frame/slot structure capable of supporting a dynamic channel/power allocation method for an FRP-based OFDMA system, in which only an AMC algorithm is performed per slot and DAC/DPA algorithms and the AMC algorithm are simultaneously performed per frame.

Additional aspect and advantages of the present general inventive concept will be set forth in part in the description which follows and, in part, will be obvious from the description, or may be learned by practice of the general inventive concept.

According to an aspect of the invention, there is provided a dynamic channel allocation method for an FRP-based OFDMA system in which each of cells has a plurality of sectors and performs data communication with a plurality of MSs therein through one or more orthogonal subchannel groups, including: selecting an MS with the smallest data-rate ratio of the sum of data rates allocated to the MS to a data rate requested by the MS as a preferential channel allocation candidate; and dynamically allocating a subcarrier of one of subchannel groups with a first FRF and a subcarrier of one of subchannel groups with a second FRF respectively to an MS in an inner cell and an MS in an outer cell, based on channel information and distance information of the MS selected as the preferential channel allocation candidate.

According to another aspect of the invention, the first FRF and the second FRF are 1 and 3, respectively.

According to a further aspect of the invention, there is provided a dynamic power allocation method for an FRP-based OFDMA system in which each of cells has a plurality of sectors and performs data communication with a plurality of MSs therein through one or more orthogonal subchannel groups, including: subtracting the power of a reference MCS level from the power of an MS with an SINR equal to or higher than a predetermined MCS level and storing the resulting power level; and performing a dynamic power allocation operation on each subchannel of an MS by adding a necessary power to one of MSs with an SINR lower than a predetermined MCS level, in which an SINR necessary for increasing a current MCS level by one is minimal.

According to a still further aspect of the invention, there is provided a dynamic channel/power allocation method for an FRP-based OFDMA system in which each of cells has an inner cell, an outer cell and a plurality of sectors and performs data communication with a plurality of MSs therein through one or more orthogonal subchannel groups, including: receiving, at each BS, a feedback channel condition from an MS provided with a service of the BS and allocating a subchannel group with a high SINR to each MS in consideration of the fairness and the distance information of each MS; and allocating power to each MS on the basis of the conditions of a channel allocated to each MS such that a multi-user diversity gain is obtained.

According to a still further aspect of the invention, there is provided a frame structure of an RFP-based OFDMA system for supporting dynamic resource allocation, the frame including: one or more frames each having four slots; and one or more superframes each having five frames.

According to a still further aspect of the invention, there is provided a slot structure of an RFP-based OFDMA system for supporting dynamic resource allocation, including: an CINR preamble for enabling an MS to measure the CINR values of all subchannel groups for each slot; a first OFDM symbol for transmitting location information of an MS for each superframe; a second OFDM symbol for transmitting location information of an MS to the MS to determine whether the MS is located in an inner cell or in an outer cell; and a plurality of third OFDM symbols for performing subcarrier reallocation and adaptive modulation using channel information of an MS.

According to a still further aspect of the invention, the slot is the first DL slot of the superframe.

According to a still further aspect of the invention, there is provided a slot structure of an RFP-based OFDMA system for supporting dynamic resource allocation, including: an CINR preamble for enabling an MS to measure the CINR values of all subchannel groups for each slot; a first OFDM symbol for transmitting location information of an MS for each superframe; and a plurality of second OFDM symbols for performing subcarrier reallocation and adaptive modulation using channel information of an MS.

According to a still further aspect of the invention, the slot is the non-first DL slot of the superframe.

According to a still further aspect of the invention, there is provided a slot structure of an RFP-based OFDMA system for supporting dynamic resource allocation, including: an CINR preamble for enabling an MS to measure the CINR values of all subchannel groups for each slot; a first OFDM symbol for transmitting location information of an MS for each superframe; and a plurality of second OFDM symbols for performing adaptive modulation for each slot.

According to a still further aspect of the invention, there is provided a method for a dynamic resource allocation operation of an RFP-based OFDMA system, including the step of performing an AMC algorithm on each slot and simultaneously performing a DCA algorithm and a DPA algorithm to reduce an overhead.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating the concept of a conventional FRP scheme;

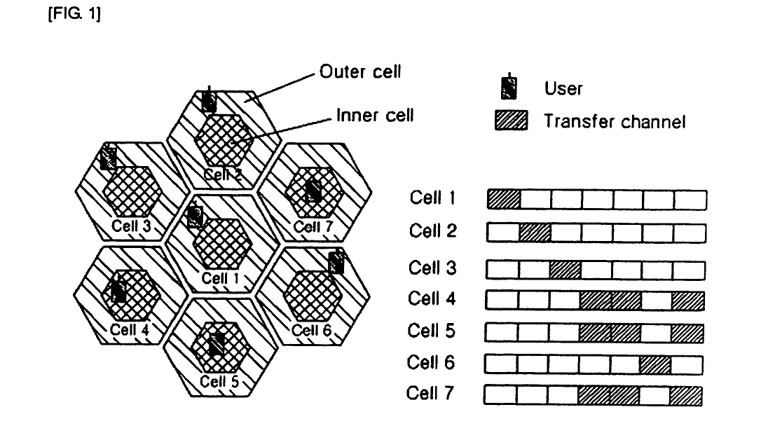

FIG. 2 is a schematic diagram illustrating a basic cell structure of an FRP-based OFDMA platform according to an embodiment of the present invention;

FIG. 3 is a diagram illustrating a radio resource structure that can be used in one cluster of FIG. 2;

FIG. 4 is a flowchart illustrating a channel allocation algorithm according to an embodiment of the present invention;

FIG. 5A illustrates a process of selecting an MS to be allocated a channel so as to allocate radio resources to MSs in a fair manner;

FIG. 5B illustrates a process of allocating the best subcarrier in a subchannel group with an FRF of 1 or 3 to an MS on the basis of the location information of MSs;

FIG. 6 is a flowchart illustrating a dynamic power allocation algorithm according to an embodiment of the present invention;

FIG. 7 is a diagram illustrating a DL frame structure for the FRP-based OFDMA platform according to an embodiment of the present invention;

FIG. 8 is a table illustrating basic parameters for implementing the dynamic channel/power allocation algorithms according to the present invention;

FIG. 9 is a diagram illustrating the first UL/DL slots of superframes for the dynamic channel/power allocation algorithms according to the present invention;

FIG. 10 is a diagram illustrating the non-first UL/DL slots of superframes for the dynamic channel/power allocation algorithms according to the present invention;

FIG. 11 illustrates the amount of the total DL overhead that is generated while the DCA/DPA algorithms are performed;

FIG. 12 illustrates the amount of the total UL overhead that is generated while the DCA/DPA algorithms are performed;

FIG. 13 illustrates UL/DA slots for performing an adaptive modulation algorithm per slot according to the present invention;

FIG. 14 illustrates the amount of DL overhead that is generated when the adaptive modulation algorithm is performed per slot and the dynamic channel/power algorithms are performed per frame; and

FIG. 15 illustrates the amount of UL overhead that is generated when the adaptive modulation algorithm is performed per slot and the dynamic channel/power algorithms are performed per frame.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, preferred embodiments of the present invention will be described in detail with reference to the accompanying drawings.

The present invention is based on an OFDMA/FDD system. Like an OFDM scheme, an OFDMA scheme uses an FFT process and an IFFT process to transmit input data in parallel on a plurality of subcarriers. Unlike the OFDM scheme, the OFDMA scheme transmits signals using a multiple access technique that allocates a plurality of subcarries respectively to a plurality of subscriber MSs. In particular, the present invention is based on an FRP-based OFDMA system.

Hereinafter, the terms “downlink” and “uplink” will be referred to as “DL” and “UL”, respectively.

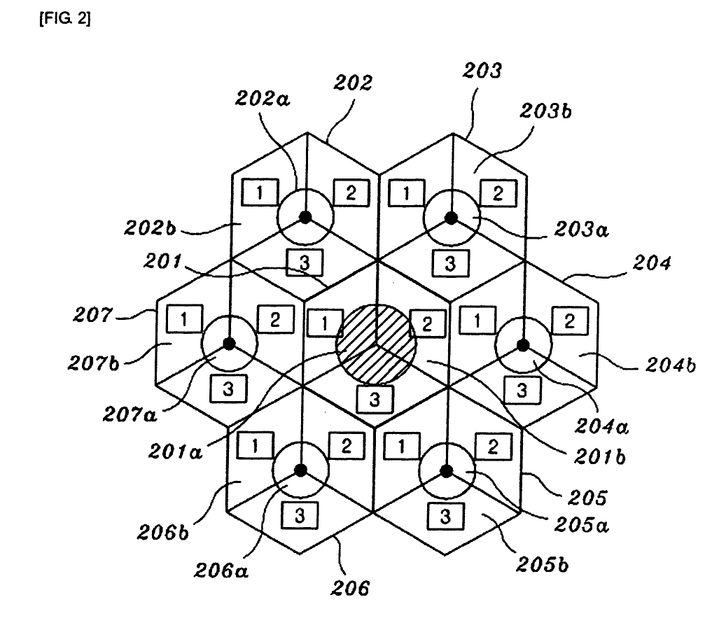

FIG. 2 is a schematic diagram illustrating a basic cell planning scheme for an FRP-based OFDMA platform according to an embodiment of the present invention.

Referring to FIG. 2, a plurality of cells 201-207 have the shape of a regular hexagon. Each of the cells 201 to 207 includes three sectors 1, 2 and 3.

The concept of an FRP scheme is applied to the sectors 1, 2 and 3 of each of the cells 201 to 207. The sector 1 of the cell 201 (202 to 207) is divided into an inner cell region 201a (202a to 207a) and an outer cell region 201b (202b to 207b), the sector 2 of the cell 201 (202 to 207) is divided into an inner cell region 201a (202a to 207a) and an outer cell region 201b (202b to 207b), and the sector 3 of the cell 201 (202 to 207) is divided into an inner cell region 201a (202a to 207a) and an outer cell region 201b (202b to 2027).

The entire network includes several clusters, and each of the clusters includes three sectors of the same cell. That is, one cell corresponds to one cluster.

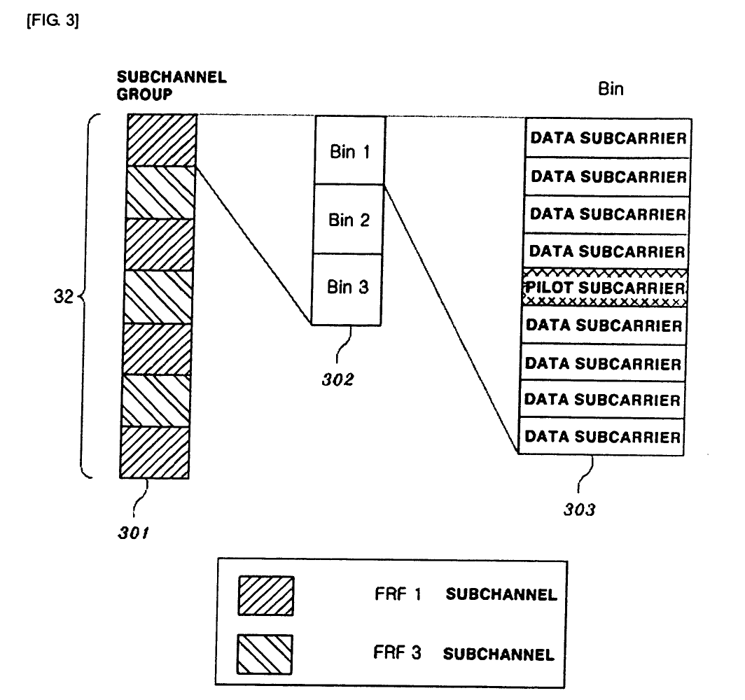

FIG. 3 is a diagram illustrating a radio resource structure that can be used in one cluster of FIG. 2.

Referring to FIG. 3, in a frequency domain, the entire band includes 32 subchannel groups, only some of which are illustrated for conciseness. It is assumed that each of the subchannel groups includes 27 subcarriers. The set of nine contiguous subcarriers is defined as “Bin” 302. One of the nine subcarriers in the Bin 302 is a pilot subcarrier that can be used for various purposes such as channel estimation and SINR (Signal to Interference and Noise Ratio) measurement.

It is assumed that an initial TX power of each subcarrier is fixed. The different subchannel groups may use different FRFs, and the FRF may be one of 1 and 3.

If a subchannel group has an FRF of 1, each of three sectors in a cluster can use all subcarriers of the subchannel group. If a subchannel group has an RFF of 3, three Bins of the subchannel group are distributed respectively to three sectors of a cluster.

An MS feedbacks the average SINR value of all subchannel groups in one superframe to a sector to which it belongs. On the basis of the feedback information, each sector allocates a channel of a subchannel group with a good SINR value to an MS. Power is allocated based on the RX SINR of the allocated channel, thereby obtaining a multi-user diversity gain.

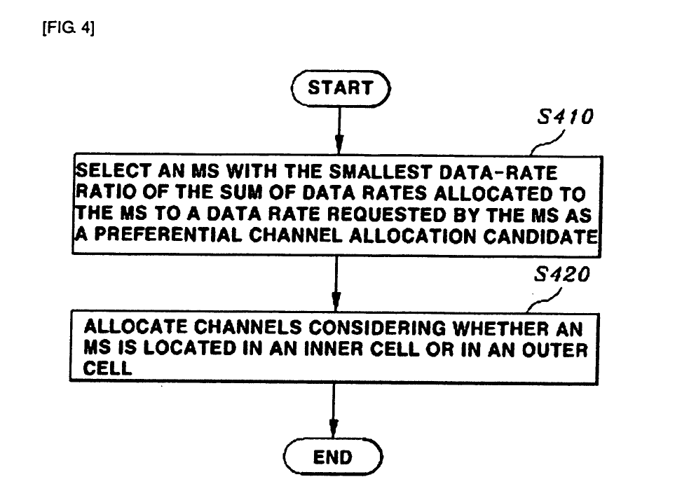

FIG. 4 is a flowchart illustrating a dynamic channel allocation (DCA) algorithm according to the present invention.

Referring to FIG. 4, a channel is allocated to an MS in consideration of the ratio of the sum of data rates allocated to the MS to a data rate requested by the MS, which will be referred to as “data-rate ratio”. That is, a channel is preferentially allocated to an MS with the smallest data-rate ratio, in step S410.

In step S420, a channel is allocated considering whether an MS is located in an inner cell or in an outer cell.

The basic concept of the FRP scheme is that a channel with a low FRF is allocated to an MS near to a BS while a channel with a high FRF is allocated to an MS remote from the BS. This basic concept is applied to the channel allocation algorithm according to the present invention. That is, on the basis of the channel conditions of MSs, a subcarrier of a subchannel group with a high SINR among subchannel groups with an FRF of 1 is allocated to an MS near to a BS, while a subcarrier of a subchannel group with a high SINR among subchannel groups with an FRF of 3 is allocated to an MS remote from the BS.

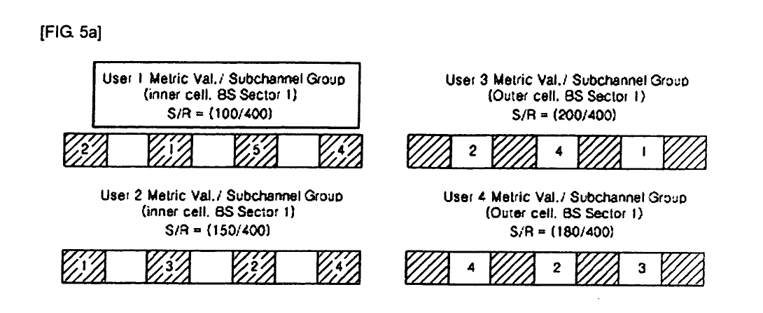

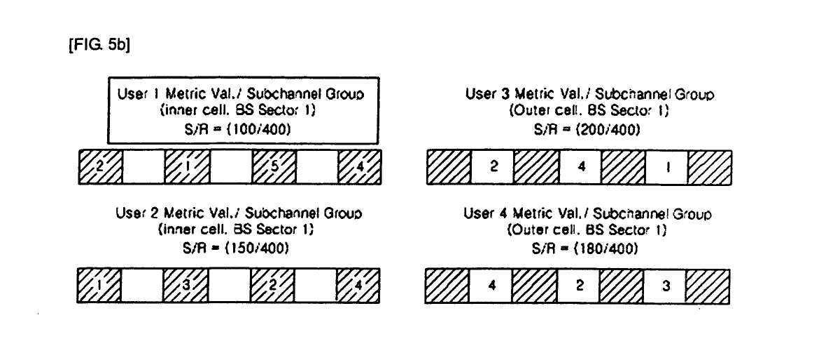

FIG. 5A illustrates a process of selecting an MS (user) 1 with the smallest data-rate ratio as a channel allocation candidate.

FIG. 5B illustrates a process of using the channel information and the distance information of an MS 1 to allocate a subcarrier of a subchannel group with a best channel condition among subchannel groups with an FRF of 1 to an MS in an inner cell and to allocate a subcarrier of a subchannel group with a best channel condition among subchannel groups with an FRF of 3 to an MS in an outer cell. Such a process is repeated to allocate channels to the respective MSs.

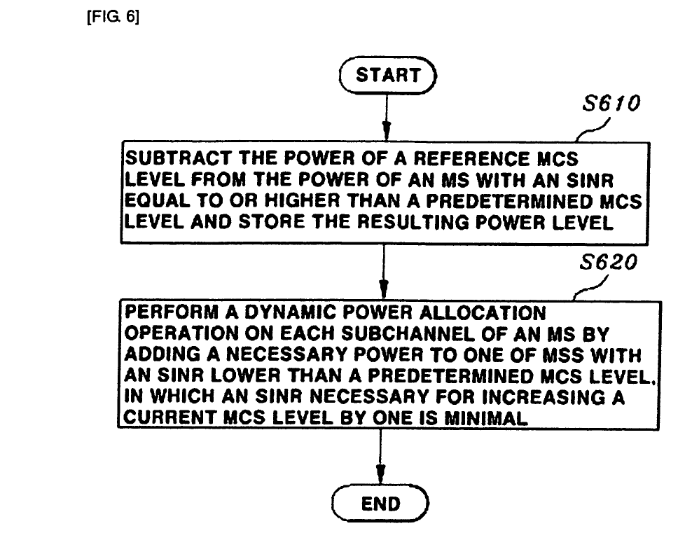

FIG. 6 is a flowchart illustrating a dynamic power allocation (DPA) algorithm according to an embodiment of the present invention. The dynamic power allocation algorithm allocates power to all MSs through the following two steps on the basis of channel conditions.

Referring to FIG. 6, the power of a reference Modulation and Coding Scheme (MCS) level is subtracted from the power of an MS with an SINR equal to or higher than a predetermined MCS level and the resulting power level is stored, in step S610.

In general, a communication system sets a plurality of available MCS levels for AMC. For example, a WiBro system sets nine MCS levels. In the WiBro system, the lowest MCS level corresponds to 1/12 Turbo Coding & QPSK and the highest MCS corresponds to 5/6 Turbo Coding & 64 QAM. The reference MCS level corresponds to any one of the nine MCS levels. The reference MCS level corresponds to the sixth of the nine MCS levels.

As described above, power is recovered from an MS with a channel better than the reference MCS level in step S610. Through step S610, the reduced power of all MSs with an SINR equal to or higher than a predetermined MCS level is stored.

In step S620, power is distributed on the basis of the recovered power. That is, a necessary power is added to one of MSs with an SINR lower than a predetermined MCS level, in which an SINR necessary for increasing a current MCS level by one is minimal, thereby performing dynamic power allocation for each subchannel of the MS.

Steps S610 and 620 are performed independently with respect to an inner cell and an outer cell. The total power added to an MS with a lower SINR does not exceed the total power added to an MS with a higher SINR.

Instead of allocating the same power to all MSs, power is allocated for each subchannel on the basis of channel conditions, thereby making it possible to obtain a multi-user diversity gain.

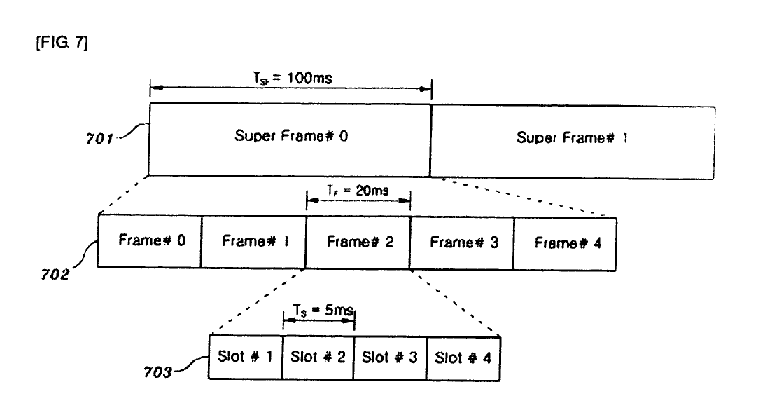

FIG. 7 is a diagram illustrating a DL frame structure for the FRP-based OFDMA platform according to an embodiment of the present invention.

Referring to FIG. 7, each superframe 701 includes five frames 702 and each of the frames 702 includes four 5-ms slots 703.

Depending on channel change rates, channel information necessary for implementing the DCA algorithm and the DPA algorithm is transmitted from an MS to a BS in units of the slot 703, the frame 702, or the superframe 701.

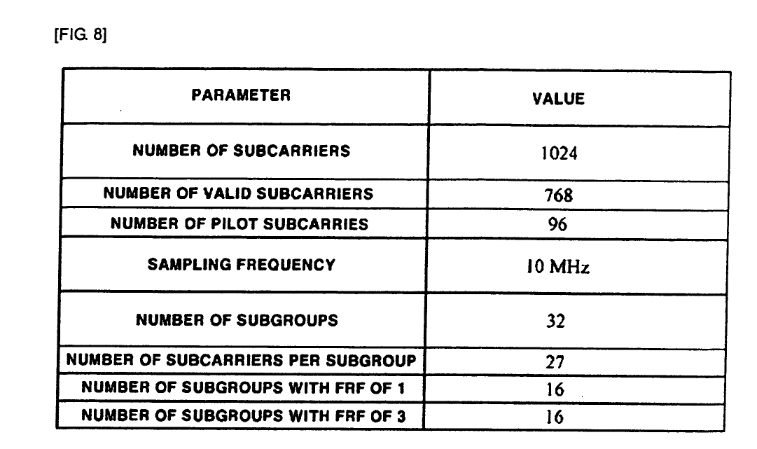

FIG. 8 is a table illustrating basic parameters for implementing the DCA and the DPA according to the present invention.

The DCA algorithm and the DPA algorithm are performed per slot 703. Therefore, in order to calculate the amount of overhead according to the DAC algorithm and the DPA algorithm, it is assumed that an MS feedbacks channel information of all groups to a BS in the units of the slot 703 and the BS transmits the location of a subcarrier, which is newly allocated according to the fedback channel information, to the MS in the units of the slot 703.

It is also assumed that the location information of the MS is transmitted once the superframe 701. In this case, the overhead that the BS must transmit to perform the DCA algorithm and the DPA algorithm can be classified into the following three items.
Location Information of the MS (in the units of the superframe)
OFDM Preamble that is provided from the BS so that the MS can measure a Carrier to Interference and Noise Ratio (CINR) of each subchannel group (in the units of the slot)
Allocation Information of a subcarrier that the BS allocates to the MS

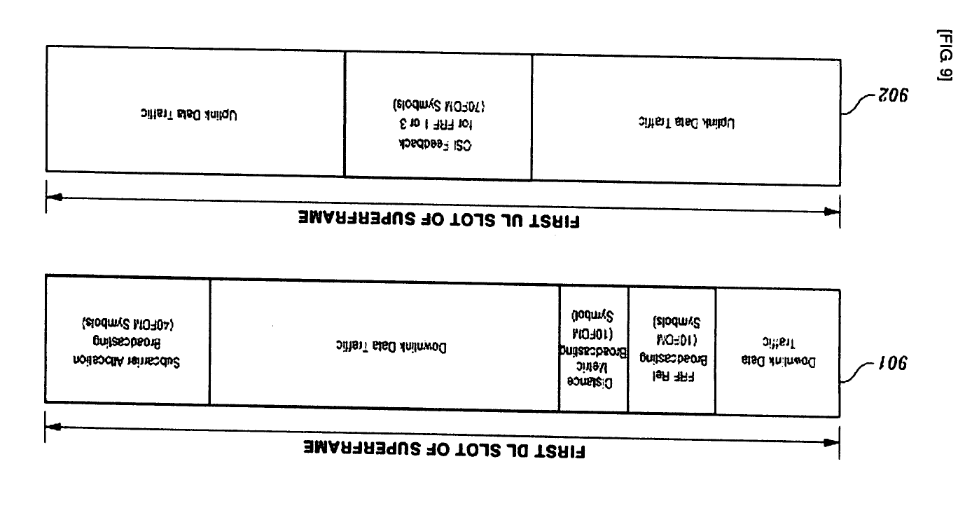

FIG. 9 is a diagram illustrating the first UL/DL slots of superframes for the dynamic channel/power allocation algorithms according to the present invention.

Referring to FIG. 9, a reference numeral 901 denotes the first DL slot of the superframe.

One CINR preamble is used in each slot so that an MS can measure the CINR values of all the subchannel groups. In addition, one OFDM symbol is used in each superframe so as to transmit the location information of the MS to each sector.

Whether an MS is located in an inner cell or in an outer cell is an important factor for determining whether the MS will perform the DCA/DPA algorithms for a subchannel group with an FRF of 1 or for a subchannel group with an FRF of 3.

If an MS in an inner cell and an MS in an outer cell are denoted as “0” and “1”, respectively, and if the location information of MSs is transmitted identically to each MS, the corresponding location information can be transmitted to each MS by using one OFDM symbol without a separate coding thereof.

In the rear section of the slot, four OFDM symbols are transmitted for subcarrier reallocation and adaptive modulation using the channel information of MSs. The reason for the use of four OFDM symbols is as follows:

In order to calculate the amount of allocation information of a subcarrier that a BS allocates to an MS on the basis of channel information transmitted from the MS to the BS, it is assumed that the number of MSs supportable in one sector is 64, the MS requires a low mobility and a high data rate, and the BS allocates nine contiguous subcarriers to each MS at a time on the basis of the channel information of each MS.

In this case, for a sector having 16 channel groups with an FRF of 1 and 16 channel groups with an FRF of 3, there are 64 (=16×3+16) in the units of nine contiguous subcarriers.

Accordingly, each sector allocates a set of 64×9 contiguous subcarriers to an MS. Therefore, 6 bits are necessary for discriminating between 64 MSs and thus a total of 384 (=6×64) bits are necessary.

If a channel coding scheme is performed according to 1/2 Turbo+4 Repetition, a total of 3072 (=384×2×4) bits are necessary. If a modulation scheme is QPSK, the DL overhead necessary for transmitting the subcarrier allocation information for the DCA algorithm is 2 [=3072/(768×2)] OFDM symbols.

Accordingly, the DL overhead necessary for the DCA/DPA algorithms for each slot is a total of 3 OFDM symbols that is the sum of one OFDM preamble for CINR measurement and two OFDM symbols corresponding to the subcarrier allocation information.

When an MS has a low mobility, the AMC as well as the DCA/DPA algorithms may be used. If the number of available AMC modes is 9, if an AMC is possible in the units of a Bin including nine contiguous subcarriers, and if the AMC is applied for each slot, 4 bits are necessary for discriminating between the nine AMC modes. If a 1/2 Turbo+4 Repetition channel coding scheme and an QPSK modulation scheme are used, the amount of additional data is less than 2[=(4×64×2×40/(768×2)) OFDM symbols.

Accordingly, the amount of data necessary for the subcarrier reallocation and adaptive modulation based on the MS channel information is 4 OFDM symbols.

A reference numeral 902 denotes the first UL slot of the superframe.

UL overhead amount necessary for the DCA/DPA algorithms is as follows:

Using an OFDM preamble for CINR measurement, an MS in an inner cell and an MS in an outer cell transmit a CINR measurement value for a subchannel group with an FRF of 1 and a CINR measurement value for a subchannel group with an FRF of 3, respectively.

It is assumed that an MS is allocated 24 valid UL subcarriers in order to calculate a UL overhead value.

If an MS is located in an inner cell, the MS must transmit the CINR values for 16 subchannel groups with an FRF of 1 to a BS.

If the CINR values are divided into 32 parts and is represented in 5 bits, the amount of information that must be transmitted from the MS to the BS is 80 (=16×5) bits.

If a 1/2 Turbo+2 Repetition channel coding scheme and an QPSK modulation scheme are used, the number of necessary OFDM symbols is smaller than 7[=(80×2×2)/(24×2)].

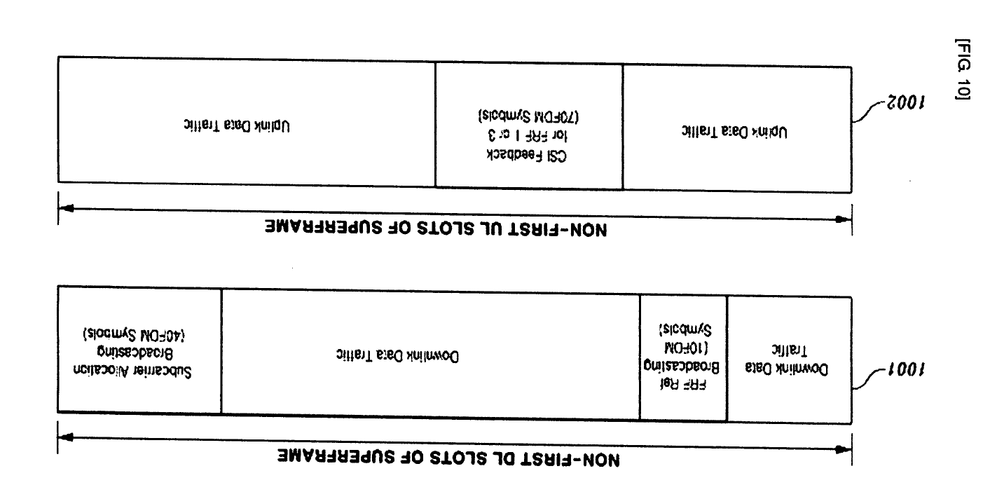

FIG. 10 is a diagram illustrating the non-first UL/DL slots of superframes for the dynamic channel/power allocation algorithms according to the present invention.

Referring to FIG. 10, a reference numeral 1001 denotes the non-first DL slots of the superframe and a reference numeral 1002 denotes the non-first UL slots of the superframe.

The non-first UL slot 1002 is identical in structure to the first UL slot 902. Unlike the first DL slot 901, the non-first DL slot 1001 does not include an OFDM symbol or informing the location information of an MS.

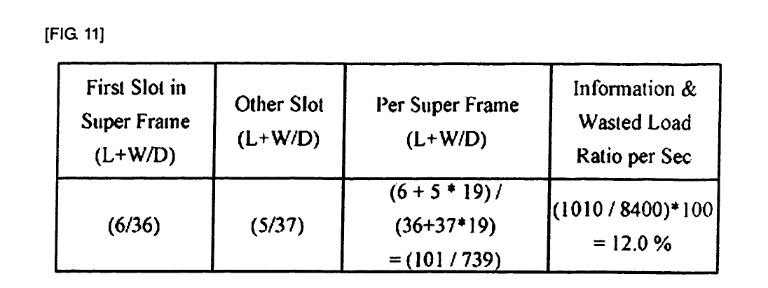

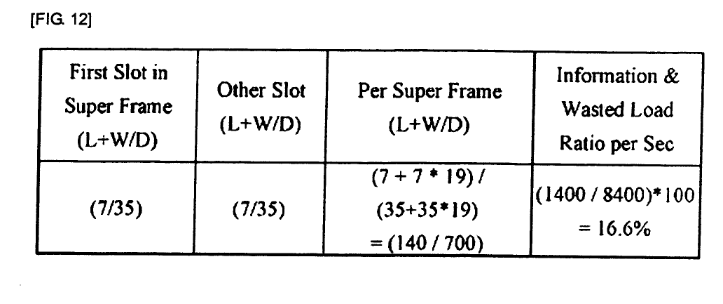

FIG. 11 illustrates the amount of the total DL overhead that is generated while the DCA/DPA algorithms are performed. FIG. 12 illustrates the amount of the total UL overhead that is generated while the DCA/DPA algorithms are performed.

As can be seen from FIGS. 11 and 12, a considerably large amount of overhead must be provided from an MS and a BS to perform the DCA/DPA algorithms for each slot.

In order to reduce the amount of overhead due to the DCA/DPA algorithms, the adaptive modulation algorithm is performed per slot and the DCA/DPA algorithms is performed per frame, instead of performing all of the adaptive modulation algorithm and the DCA/DPA algorithms per slot.

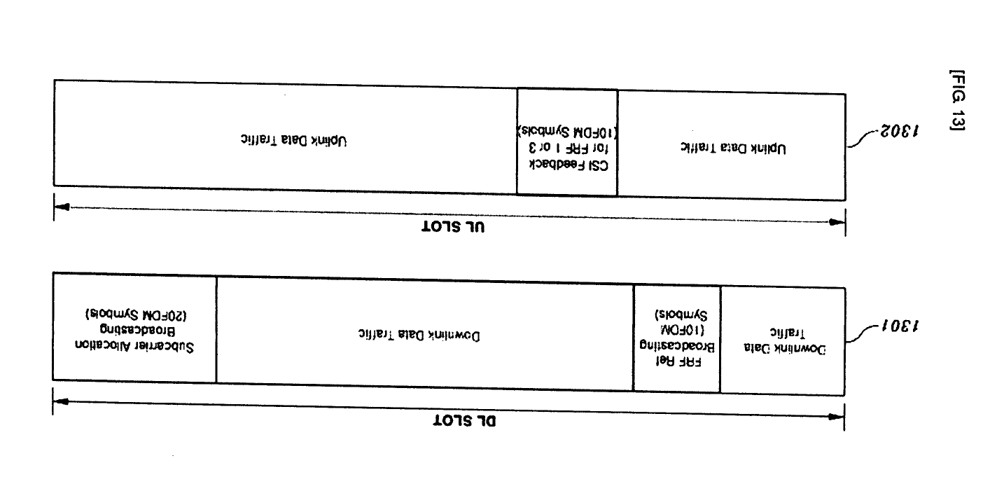

The structure of the UL slot for performing only the adaptive modulation algorithm is illustrated in FIG. 13. The first slot of each frame is identical in structure to the slots 1001 and 1002 of FIG. 12, because the adaptive modulation algorithm and the DAC/DPA algorithms are performed simultaneously. The first slot of each super frame is identical in structure to the slots 901 and 902 of FIG. 9, because the adaptive modulation algorithm and the DAC/DPA algorithms are performed simultaneously and the location information of each MS is transmitted thereto.

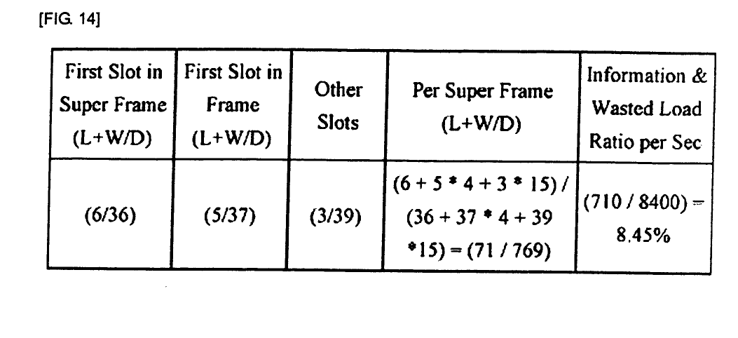

Accordingly, the total DL overhead is reduced as illustrated in FIG. 14. When only the adaptive modulation algorithm is performed per slot, the overhead is 7.1% (=3/14×100). As can be seen from FIG. 14, when the DCA/DPA algorithms are further performed, the overhead increases by about 1.35%.

Because a CINR value needs to be transmitted for only a subchannel allocated in each slot, an UL overhead is 1 OFDM symbol and the CINR value for the entire subchannel group is transmitted so as to dynamically allocate resources once a frame.

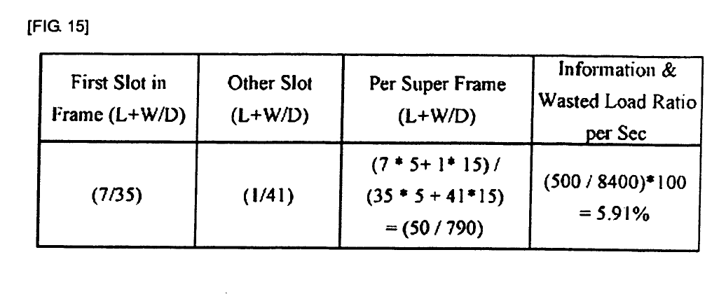

FIG. 15 illustrates the total UL overhead. As can be seen from FIG. 15, the total UL overhead can be considerably reduced by only performing the adaptive modulation algorithm per slot and the dynamic resource allocation operation per frame, instead of performing the adaptive modulation algorithm and the dynamic resource allocation operation per slot.

As described above, the present invention has the following effects.

First, each MS feedbacks the channel conditions to its serving BS and each BS allocates a good channel to each MS in a fair manner, thereby obtaining the multi-user diversity gain. This dynamic resource allocation algorithm is applied to the FRP-based cell planning scheme such that a channel with a high FRF is allocated to an MS in an outer cell remote from the corresponding BS, thereby making it possible to improve the UL throughput and the outage probability.

Second, only the AMC algorithm is performed per slot and the DAC/DPA algorithms and the AMC algorithm are simultaneously performed per frame, thereby making it possible to reducing the overhead. In addition, the DL throughput can be enhanced by quantitatively analyzing the DL overhead and the UL overhead.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A dynamic channel allocation method for an FRP-based OFDMA system in which each of cells has a plurality of sectors and performs data communication with a plurality of MSs therein through one or more orthogonal subchannel groups, the dynamic channel allocation method comprising:
selecting an MS with the smallest data-rate ratio of the sum of data rates allocated to the MS to a data rate requested by the MS as a preferential channel allocation candidate; and
dynamically allocating a subcarrier of one of subchannel groups with a first FRF and a subcarrier of one of subchannel groups with a second FRF respectively to an MS in an inner cell and an MS in an outer cell, based on channel information and distance information of the MS selected as the preferential channel allocation candidate.

2. The dynamic channel allocation method according to claim 1,
wherein the first FRF and the second FRF are 1 and 3, respectively.

3. A dynamic power allocation method for an FRP-based OFDMA system in which each of cells has a plurality of sectors and performs data communication with a plurality of MSs therein through one or more orthogonal subchannel groups, the dynamic power allocation method comprising:
subtracting the power of a reference MCS level from the power of an MS with an SINR equal to or higher than a predetermined MCS level and storing the resulting power level; and
performing a dynamic power allocation operation on each subchannel of an MS by adding a necessary power to one of MSs with an SINR lower than a predetermined MCS level, in which an SINR necessary for increasing a current MCS level by one is minimal.

4. A dynamic channel/power allocation method for an FRP-based OFDMA system in which each of cells has an inner cell, an outer cell and a plurality of sectors and performs data communication with a plurality of MSs therein through one or more orthogonal subchannel groups, the dynamic channel/power allocation method comprising:
receiving, at each BS, a feedback channel condition from an MS provided with a service of the BS and allocating a subchannel group with a high SINR to each MS in consideration of the fairness and the distance information of each MS; and
allocating power to each MS on the basis of the conditions of a channel allocated to each MS such that a multi-user diversity gain is obtained.

5. A frame structure of an RFP-based OFDMA system for supporting dynamic resource allocation, the frame structure comprising:
one or more frames each having four slots; and
one or more superframes each having five frames.

6. The frame structure according to claim 5,
wherein the slot is configured in units of 5 ms.

7. A slot structure of an RFP-based OFDMA system for supporting dynamic resource allocation, the slot structure comprising:
an CINR preamble for enabling an MS to measure the CINR values of all subchannel groups for each slot;
a first OFDM symbol for transmitting location information of an MS for each superframe;
a second OFDM symbol for transmitting location information of an MS to the MS to determine whether the MS is located in an inner cell or in an outer cell; and
a plurality of third OFDM symbols for performing subcarrier reallocation and adaptive modulation using channel information of an MS.

8. The slot structure according to claim 7,
wherein the slot is the first DL slot of the superframe.

9. The slot structure according to claim 7,
wherein the number of the third OFDM symbols is 4.

10. A slot structure of an RFP-based OFDMA system for supporting dynamic resource allocation, the slot structure comprising:
an CINR preamble for enabling an MS to measure the CINR values of all subchannel groups for each slot;
a first OFDM symbol for transmitting location information of an MS for each superframe; and
a plurality of second OFDM symbols for performing subcarrier reallocation and adaptive modulation using channel information of an MS.

11. The slot structure according to claim 10,
wherein the slot is the non-first DL slot of the superframe.

12. A slot structure of an RFP-based OFDMA system for supporting dynamic resource allocation, the slot structure comprising:
an CINR preamble for enabling an MS to measure the CINR values of all subchannel groups for each slot;
a first OFDM symbol for transmitting location information of an MS for each superframe; and
a plurality of second OFDM symbols for performing adaptive modulation for each slot.

13. A method for a dynamic resource allocation operation of an RFP-based OFDMA system, the method comprising performing an AMC algorithm on each slot and simultaneously performing a DCA algorithm and a DPA algorithm to reduce an overhead.
